(19) United States
(12) Patent Application Publication
(10) Pub. No.: US 2002/0043910 A1
(43) Pub. Date: Apr. 18, 2002

(54) IMAGE FORMING APPARATUS WITH A TABLE TOP ABOVE A PAPER DISCHARGE AREA

(76) Inventors: MASANORI HASHIMOTO, YOKOHAMA-SHI (JP); TAKAFUMI HOSHIMURA, YOKOHAMA-SHI (JP); MASAHIRO YONEKAWA, TOKYO (JP); MASAHIRO KURITA, YOKOHAMA-SHI (JP); KAZUYUKI SAITOH, TOKYO (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/227,878

(22) Filed: Jan. 11, 1999

(30) Foreign Application Priority Data
Jan. 9, 1998 (JP) 10-015168

(51) Int. Cl. A47B 81/00; G03G 15/00

(52) U.S. Cl. 312/282; 312/277; 108/92; 399/107

(57) ABSTRACT

An image forming apparatus includes a table top formed above a paper discharge area. The paper discharge area is formed on a top surface of a main body of the image forming apparatus. Support members are provided on the top surface of the main body of the image forming apparatus, and the table top is supported by the support members. This structure allows the area above the paper discharge area on the top surface of the image forming apparatus not to be wasted and to be efficiently utilized.

### BACKGROUND OF THE INVENTION

1. Field of the Invention

The present invention is directed to an image forming apparatus which includes a paper discharging area on a top surface, and which provides a table top above the paper discharge area.

2. Discussion of the Background

Recently, as background image forming apparatuses have become more compact, a paper discharge area, e.g. a receiving tray, for receiving paper sheets having images formed thereon has been positioned on a top of an image forming apparatus. However, a result of this placement of a paper discharge area on a top of an image forming apparatus is that the space above the image forming apparatus cannot be effectively utilized. That is, nothing can be placed above the image forming apparatus since the top of the image forming apparatus must be easily accessible to remove paper sheets from the top surface mounted paper discharge area. This may become significant if the image forming apparatus is placed at a low position so that a significant amount of space above the image forming apparatus is wasted. On the other hand, if the image forming apparatus is raised to minimize the space above the image forming apparatus, it then becomes difficult to remove the discharged paper sheets from the top surface mounted paper discharge area. Furthermore, dust accumulates on the discharged paper sheets.

Particularly, in large size printers such problems are worsened because the large size printers occupy a greater space, and thereby a greater space above such large size printers may be wasted.

### SUMMARY OF THE INVENTION

Accordingly, an object of the present invention is to provide novel structures for an image forming apparatus which overcome the above-noted and other drawbacks.

A more specific object of the present invention is to provide a novel image forming apparatus which allows an area above a top surface positioned paper discharge receiving area to be effectively utilized.

The present invention achieves these and other objects by providing a novel image forming apparatus with a support member structure formed on a top surface of the image forming apparatus, and by further including a table top which is supported by this support member structure. The table top can have several structural elements including transparent portions, notched portions, and hinged portions. Further, the support member structure can take several forms and can be adjustable in height.

### BRIEF DESCRIPTION OF THE DRAWINGS

A more complete appreciation of the present invention, and many of the attendant advantages thereof, will be readily obtained as the same becomes better understood when read in conjunction with the following drawings, wherein:

FIG. 1 shows a first embodiment of a novel image forming apparatus of the present invention;

FIG. 2 shows a second embodiment of a novel image forming apparatus of the present invention;

FIGS. 3(a) and 3(b) show a third embodiment of a novel image forming apparatus of the present invention, FIG. 3(a) showing a perspective view and FIG. 3(b) showing a side view;

FIG. 4 shows a fourth embodiment of a novel image forming apparatus of the present invention;

FIG. 5 shows a fifth embodiment of a novel image forming apparatus of the present invention;

FIG. 6 shows a sixth embodiment of a novel image forming apparatus of the present invention; and

FIG. 7 shows a seventh embodiment of a novel image forming apparatus of the present invention.

### DESCRIPTION OF THE PREFERRED EMBODIMENTS

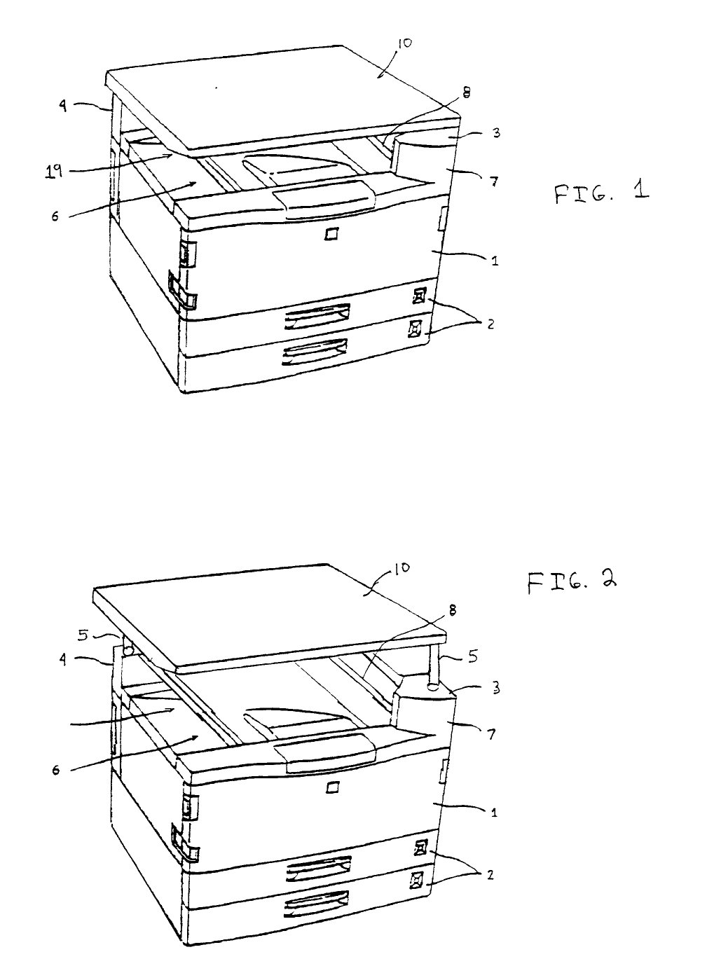

Referring now to the drawings, wherein like reference numerals designate identical or corresponding parts throughout the several views, a first embodiment of the present invention is now described with reference to FIG. 1.

FIG. 1 shows the image forming apparatus of the present invention in the form of a printer. As can be clearly understood by those of ordinary skill in the art, the image forming apparatus of the present invention can be in a form other than a printer, for example a copier, a facsimile, a multi-function machine, etc. The image forming apparatus of FIG. 1 includes a main body 1, sheet supplying trays 2, a paper discharge outlet 8 for discharging paper sheets having images formed thereon, and a paper discharge receiving area 6 for receiving the paper sheets output from the paper discharge outlet 8. The paper discharge receiving area 6 typically includes a sheet-receiving tray located on a top surface of the main body 1 of the image forming apparatus. Further, a protrusion 7 is formed about the paper discharge outlet 8. The image forming apparatus of FIG. 1 operates such that paper sheets fed from the paper sheet supplying trays 2 are provided to the main body 1 in which image formation is executed, and then paper sheets having images formed thereon are discharged from the paper discharge outlet 8 to the paper discharge receiving area 6.

As further features of the present invention, the image forming apparatus of FIG. 1 further includes spacers 3 and 4 and a table top 10 formed above the main body 1 of the image forming apparatus. The table top 10 is further formed above the paper discharge receiving area 6 of the image forming apparatus. The spacers 3 and 4 form a support body for the table top 10. The spacer 3 can be shaped similar to the protrusion 7 and can be installed above the protrusion 7. The spacer 4 can be formed at a backside of the main body 1 and can take the form of any support portion coupled with and formed above the main body 1 of the image forming apparatus. The spacer 4 can also include an area (not shown) for retracting connectors for connecting with a line cord, etc. The table top 10 can be coupled with and supported by the spacers 3 and 4. Further, the table top 10 can include a beveled front edge 19 to allow easier access to the paper discharge receiving area 6.

As a further feature of the present invention, and in a further embodiment as shown in FIG. 2, the spacers 3 and 4 may have extending portions 5 which are adjustable in height. That is, extending portions 5 may be provided between the spacers 3 and 4 and the table top 10, and spacers 5 can be adjustable in height

In the embodiments of FIGS. 1 and 2 the table top 10 is supported by the spacers 3 and 4 (and optionally extending portions 5) along right and back edges of the table top 10. However, if any increase in the stiffness of table top 10 is desired, a high stiffness bar (not shown) may be provided under the table top 10 extending, e.g., from the spacer 4 along a left-side edge of the table top 10. A column (not shown) could also be provided at, e.g., the left-side edge of the table top 10.

With such structures in the present invention as shown in FIGS. 1 and 2, an area above a paper discharge area 6 is usable since an area of the table top 10 is usable. Further, the table top 10 is still provided high enough above the paper discharge area 6 by being placed on the spacers 3 and 4, and optionally height adjustable members 5, to allow easy access to the paper sheets discharged onto the paper discharge receiving area 6.

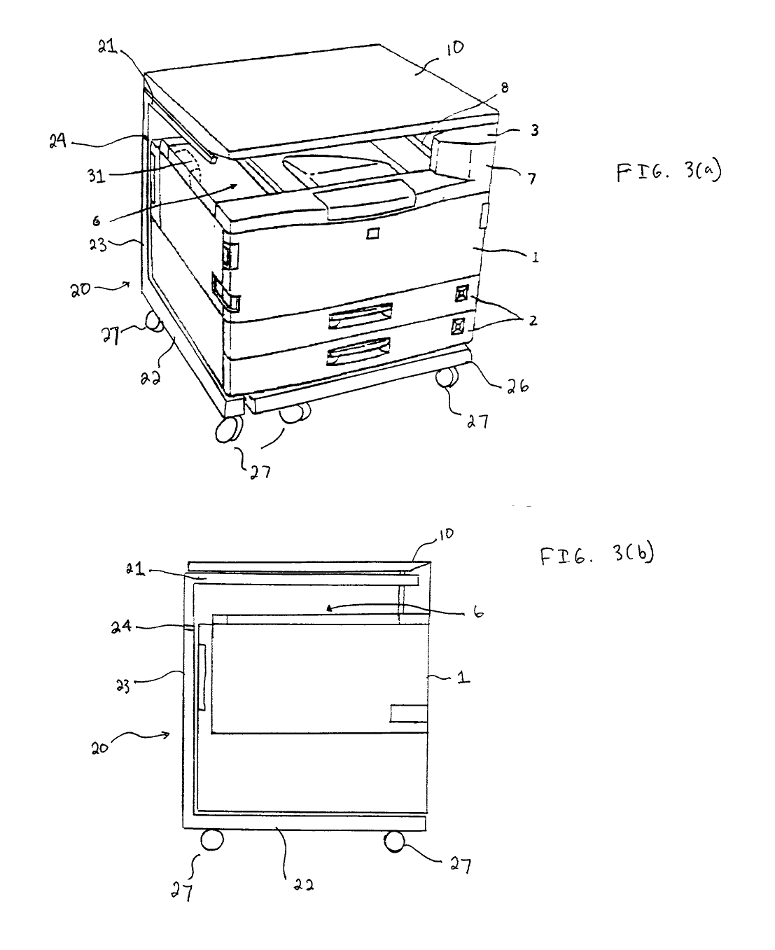

FIGS. 3(a) and 3(b) show a third embodiment of the present invention which is essentially a modification of the first embodiment of FIG. 1 such that the support structure for the table top 10 includes a leg 20, e.g. instead of the spacer 4, positioned at a backside of the main body 1. The leg 20 can operate in conjunction with a further support member 26 on which the main body 1 rests. Both of the leg 20 and the further support member 26 may have wheels 27, which would thereby allow easy movement of the image forming apparatus.

Further, the leg 20 can have a U-shaped structure, and thereby provide very solid support for the table top 10. The leg 20 can include two horizontal support portions 21 and 22 and a vertical connecting portion 23. The leg 20 can also be adjustable in height by including an extendable portion 24 in the vertical connecting portion 23.

As noted above, the leg 20 can be positioned such that its vertical connecting portion 23 is formed at a backside of the main body 1 of the image forming apparatus. Further, the leg 20 can be positioned just at a side of the main body 1 of the image forming apparatus. In this instance, the side of the main body 1 of the image forming apparatus can include a notch 31 into which the vertical connecting portion 23 of the leg 20 is inserted. However, the leg 20 can also be positioned at different places, and again as one example at the backside of the main body of the image forming apparatus as shown in FIGS. 3(a) and 3(b). To assist this positioning, the backside of the main body 1 of the image forming apparatus can also include a notch. Of course the leg can be positioned at different positions and in different notches, e.g. a notch as a hole can also extend through the image forming apparatus, if desired.

This further embodiment of FIG. 3 of the present invention provides more structural support for the table top 10 by including the leg 20 to support the table top 10. This embodiment of FIG. 3 also provides an easy structure to allow movement of the entire image forming apparatus if leg 20 has wheels 27 and when support member 26 with wheels 27 is provided.

In each of the first, second, and third embodiments of FIGS. 1, 2, and 3, the table top 10 can also include the beveled portion 19 which allows slightly easier access to the paper discharge area 6.

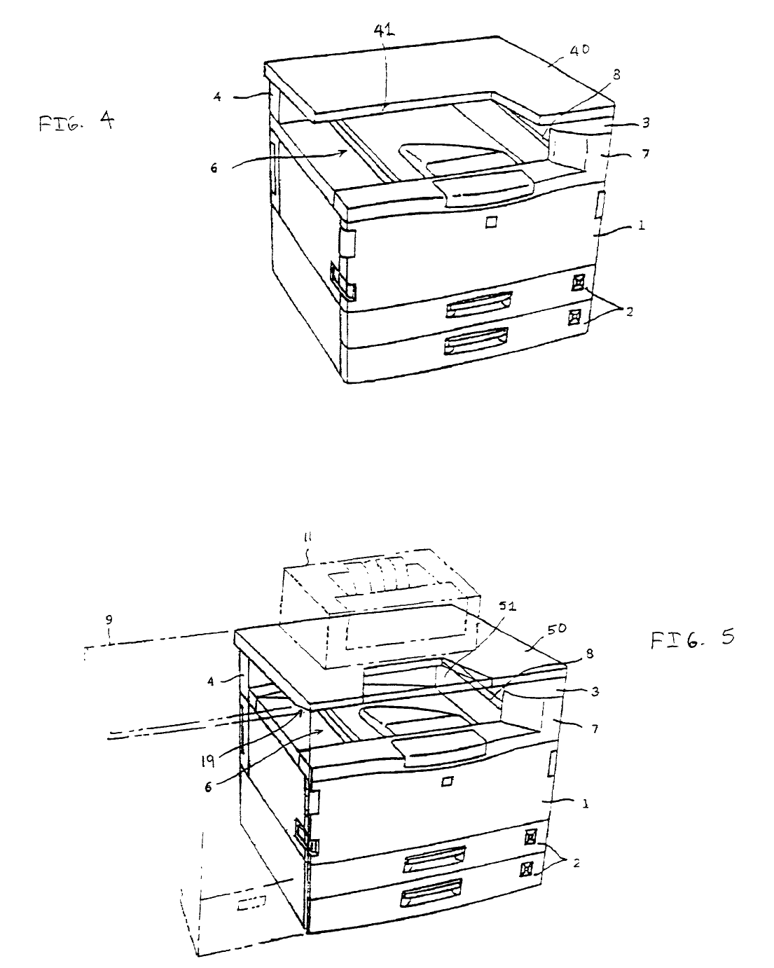

A fourth embodiment of the present invention is shown in FIG. 4. This fourth embodiment of FIG. 4 is similar to the embodiment of FIG. 1 except that a different table top 40 is provided which includes a notched portion 41. This notched portion 41 allows easier access to the paper sheets discharged to the paper discharge area 6. This embodiment shown in FIG. 4 can also implement the leg 25 and further support 26 shown in FIG. 3, as is clearly apparent to those skilled in the art, and can also include height adjustable extending portions 5.

A fifth embodiment of the present invention is shown in FIG. 5 in which a different table top 50 is provided. The table top 50 in FIG. 5 includes a transparent portion 51 to allow easier visibility of the paper sheets discharged to the paper discharge area 6.

As shown in this embodiment of FIG. 5, the table top 50 can be positioned at a height which is the same as an adjacent desk 9 to provide a good appearance. The dimensions of the depth of the transparent member 51 can be selected to allow a remaining space on the table top 50 which can still fit a small printer 11. FIG. 5 also shows how the table top 50 can be provided at a height of adjacent desk 9, as can be done in any of the embodiments of the present invention. This embodiment of FIG. 5 can also include the leg member 20 and further support 26, and height adjustable extending portions 5.

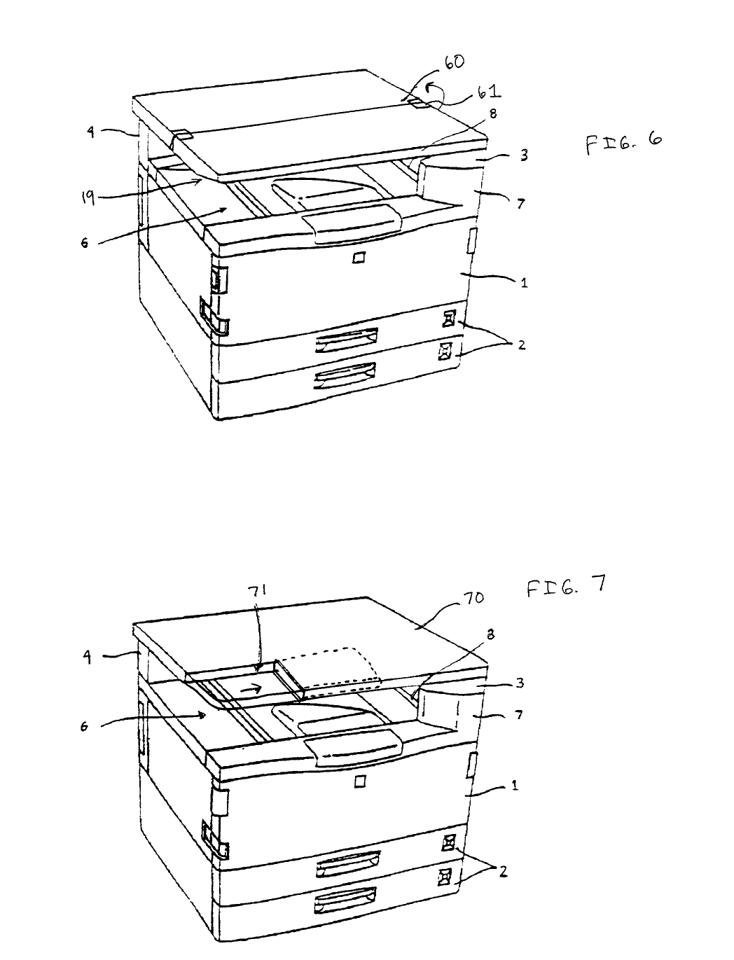

FIG. 6 shows a sixth embodiment of the present invention similar to the embodiment of FIG. 1 except that a table top 60 is provided which includes hinged portions 61 so that the table top 60 can pivot away from the main body 1 of the image forming apparatus around the hinge elements 61. This operation of pivoting a front of table top 60 can provide easier access to the paper discharge receiving area 6.

FIG. 7 shows a seventh embodiment of the present invention similar to the previous embodiments except that a table top 70 is provided which includes a transparent portion 71 which can slide into the table top 70. In this embodiment of FIG. 7 the transparent portion 71 can be slid into the table top 70 to provide easier access to the paper discharge receiving area 6.

Each of these further embodiments shown in FIGS. 6 and 7 of the present invention can also implement the leg 20 and further support 26 as detailed in the embodiment of FIG. 3 above, and can also include height adjustable extending portions 5.

Obviously, numerous additional modifications and variations of the present invention are possible in light of the above teachings. It is particularly the case that different combinations of features in the embodiments disclosed above can be combined in different manners than expressly disclosed above. As noted above, each of the embodiments of the present invention can include the leg support 20 and further support 26 and can include height adjustable extending members 5. Other possible combinations of features shown in the several embodiments noted above are also clearly possible, as will be apparent to those of ordinary skill in the art. It is therefore to be understood that within the scope of the appended claims, the present invention may be practiced otherwise than as specifically disclosed herein.

This document is based on Japanese Priority document 10-015168 filed in the Japanese Patent Office on Jan. 9, 1998, the entire contents of which are incorporated herein by reference.

1. An image forming apparatus having a main body, comprising:
a paper discharging area configured on a top surface of the main body of the image forming apparatus;
a support body configured to be coupled with and formed above the main body of the image forming apparatus; and
a table top configured to be coupled with, supported by, and formed above the support body.

2. An image forming apparatus according to claim 1, wherein the support body includes a leg supporting the table top.

3. An image forming apparatus according to claim 2, wherein the leg further supports the main body of the image forming apparatus.

4. An image forming apparatus according to claim 3, wherein the leg includes a vertical member formed at a back of the main body of the image forming apparatus.

5. An image forming apparatus according to claim 3, wherein the leg includes a vertical member formed in a notch in a main body of the image forming apparatus.

6. An image forming apparatus according to claim 1, wherein the table top has a transparent portion at a front side of the main body of the image forming apparatus.

7. An image forming apparatus according to claim 6, wherein the transparent portion is configured to slide into the table top.

8. An image forming apparatus according to claim 1, wherein the table top is notched at a front face of the main body of the image forming apparatus.

9. An image forming apparatus according to claim 1, wherein the table top is at a desk height.

10. An image forming apparatus according to claim 1, wherein the support body includes a height adjustable member.

11. An image forming apparatus according to claim 1, wherein the table top is beveled at a front side of the main body of the image forming apparatus.

12. An image forming apparatus according to claim 1, wherein the table top includes a front portion and a back portion, the front portion configured to pivot onto the back portion.

13. An image forming apparatus according to claim 1, wherein the main body of the image forming apparatus includes a protrusion formed around a paper discharge outlet coupled with at least a portion of the support body.

14. An image forming apparatus having a main body, comprising:
paper discharging means configured on a top surface of the main body of the image forming apparatus for receiving discharged paper;
support means coupled with and formed above the main body of the image forming apparatus; and
table means to be coupled with, supported by, and formed above the support means.

15. An image forming apparatus according to claim 14, wherein the support means includes leg means supporting the table means.

16. An image forming apparatus according to claim 15, wherein the leg means further supports the main body of the image forming apparatus.

17. An image forming apparatus according to claim 16, wherein the leg means includes a vertical member formed at a back of the main body of the image forming apparatus.

18. An image forming apparatus according to claim 16, wherein the leg means includes a vertical member formed in a notch in a main body of the image forming apparatus.

19. An image forming apparatus according to claim 14, wherein the table means has a transparent portion at a front side of the main body of the image forming apparatus.

20. An image forming apparatus according to claim 19, wherein the transparent portion is configured to slide into the table means.

21. An image forming apparatus according to claim 14, wherein the table means is notched at a front face of the main body of the image forming apparatus.

22. An image forming apparatus according to claim 14, wherein the table means is at a desk height.

23. An image forming apparatus according to claim 14, wherein the support means includes a height adjustable means for adjusting a height of the table means.

24. An image forming apparatus according to claim 14, wherein the table means is beveled at a front side of the main body of the image forming apparatus.

25. An image forming apparatus according to claim 14, wherein the table means includes a front portion and a back portion, the front portion configured to pivot onto the back portion.

26. An image forming apparatus according to claim 14, wherein the main body of the image forming apparatus includes protrusion means formed around a paper discharge outlet coupled with at least a portion of the support means.
